(19) United States
(12) Patent Application Publication
(10) Pub. No.: US 2008/0221991 A1
(43) Pub. Date: Sep. 11, 2008

(54) Method of Staging Product

(76) Inventor: James H. Johnson, Jr., Lexington, KY (US)

Correspondence Address: KING & SCHICKLI, PLLC, 247 NORTH BROADWAY, LEXINGTON, KY, 40507, US

(21) Appl. No.: 11/996,761

(22) PCT Filed: Jul. 25, 2006
(86) PCT No.: PCT/US06/28761

§ 371 Date: Jan. 25, 2008

Related U.S. Application Data
(60) Provisional application No. 60/702,476, filed on Jul. 26, 2005.
(60) Provisional application No. 60/771,371, filed on Feb. 8, 2006.

(51) Int. Cl. G06Q 30/00

(52) U.S. Cl. 705/14

(57) ABSTRACT

A method for staging product includes the steps of placing a storage structure at a site of a product retailer, providing storage use rights to a product vendor and marketing advertising space on the storage structure.

This application claims the benefit of U.S. provisional patent applications Ser. Nos. 60/702,476 filed on 26 Jul. 2005 and 60/771,371 filed on 8 Feb. 2006.

### TECHNICAL FIELD

The present invention relates generally to the storage and outdoor advertising fields and more particularly to a method for staging product for a vendor.

### BACKGROUND OF THE INVENTION

Many product vendors including particularly but not exclusively limited to dairy and beverage vendors must provide just-in-time delivery services to their high demand retail customers. Typically those retail customers require daily or every other day delivery of products such as milk, beer, soft drinks and sport drinks. It is a significant management challenge to design and develop an efficient delivery schedule to meet retailer demand. Further, transportation costs have recently spiked due to increases in gasoline and diesel fuel prices. Unfortunately further price increases are anticipated for both the short and long term.

The present invention relates to a method for staging product wherein transportation and manpower costs may be reduced dramatically by staging inventory on site at retailer locations. Such an approach also simplifies the development and coordination of delivery schedules.

### SUMMARY OF THE INVENTION

In accordance with the purposes of the present invention as described herein, a method is provided for staging product. The method comprises placing a storage structure at a site of a product retailer, providing storage use rights to a product vendor and marketing advertising space on the storage structure.

The method may further include charging a fee to the product vendor for use of storage space in the storage structure. In one possible embodiment that fee is a certain percentage of the product vendor's amortized cost savings for use of storage space in the storage structure.

In accordance with additional aspects of the present invention, the method may include the customizing of an internal storage space in the storage structure to meet the needs of the product vendor. In addition the method may include the customizing of an exterior of the storage structure to incorporate trade dress or building architecture of the product retailer. Further the method may include providing climate control for an internal space in the storage structure.

In accordance with yet additional aspects, the present method may include the rotating of advertising provided on the storage structure. In addition the method may include illuminating advertising provided on the storage structure. The method may also include providing short range radio advertising in a limited area around the storage structure. In accordance with yet additional aspects, the present invention may include the constructing of the storage structure from modular building materials. In addition the method may include removing the storage structure after a predetermined period of time and even reusing the storage structure at a different location.

Still further the method may include providing the storage structure with a projecting roof cap and down lighting advertising provided on a wall of the storage structure with a light source carried by the roof cap. Additionally or alternatively, the method may include providing back lighting for advertising on the storage structure. Still further the method may include providing the storage structure with interior lighting and even customizing at least a portion of the internal space in the storage structure to meet the needs of the product retailer.

In the following description there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of this specification, illustrates several aspects of the present invention, and together with the description serves to explain certain principles of the invention. In the drawing:

FIG. 1 is a perspective view of a storage structure provided to a customer through the method of the present invention; and

FIG. 2 is a schematical end elevational view of a storage structure through the open end doors.

Reference will now be made in detail to the present preferred embodiment of the invention, an example of which is illustrated in the accompanying drawing.

### DETAILED DESCRIPTION OF THE INVENTION

As noted above, the present method relates to product staging. That method may be generally and broadly described as including the steps of placing a storage structure at a site of a product retailer and providing storage use rights to a product vendor. The method also includes the step of marketing advertising space on the storage structure. Thus, it is possible to generate two income streams. The first is the generated income for use of the storage space. The second is the generated income for advertising rights on the side of the storage structure.

The method may include many additional steps in numerous combinations and permutations. Those additional steps include charging a fee to the product vendor for use of the storage space in the storage structure. More specifically, the method may include charging the product vendor a certain percentage of the product vendor's amortized cost savings for use of storage space in the storage structure. Since the present method provides the product vendor with the ability to maintain an onsite product inventory (i.e. product staging), the vendor's costs for providing just-in-time delivery of product to the product retailer are significantly reduced and the savings may be substantial.

In addition, the method may include customizing an internal storage space in the storage structure to meet the needs of the product vendor. Such needs include but are not limited to particular rack, shelving and partitioning layouts as required or desired by the customer for purposes of inventory storage and control. The interior customization may be tailored to integrate with inventory control technology such as bar coding. Further, it should be appreciated that at least a portion of the interior space may also be customized to meet the needs of the product retailer where the product vendor and product retailer will share space in the storage structure.

In accordance with further aspects, the present method may include customizing an exterior of the storage structure to incorporate trade dress and/or building architecture of the product retailer. For example, the storage structure may be provided with a roof cap incorporating the trade dress or logo of a product retailer so that the building blends in with previously existing site structures.

Further, the method may include providing climate control for an interior space in the storage structure. For example, at least a portion of the interior space may be maintained at freezer temperatures for storing frozen products such as ice cream. Another portion or all of the structure may be maintained at refrigeration temperatures for storing sports drinks, soft drinks, beer, milk or the like. Advantageously, storage at serving temperatures allows the retailer to restock in-store supplies with product already at the desired serving temperature. This is particularly important for many customers who purchase such beverages with a desire for immediate consumption. Further, it also reduces the load on the retailer's refrigeration equipment since the product is already at refrigeration temperatures at the time of restocking the shelves in the retailer's refrigerator.

Still further, the method may include rotating advertising provided on the storage structure. The method may also include illuminating the advertising provided on the storage structure. That illuminating may be provided by back lighting, down lighting or up lighting advertising on the storage structure.

In accordance with additional aspects of the invention, the method may include providing short range radio advertising in a limited area around the storage structure. Such short range radio advertising may incorporate short range radio transmission advertising such as low wattage transmission on 89.1 FM. The transmitter may be located anywhere within a given radius (e.g. within 200 yds.) of the storage structure or even on the storage structure.

Still further the method may include constructing the storage structure from modular building materials. The method may also include the steps of removing the storage structure following a predetermined period of time and subsequently reusing that storage structure at a different site.

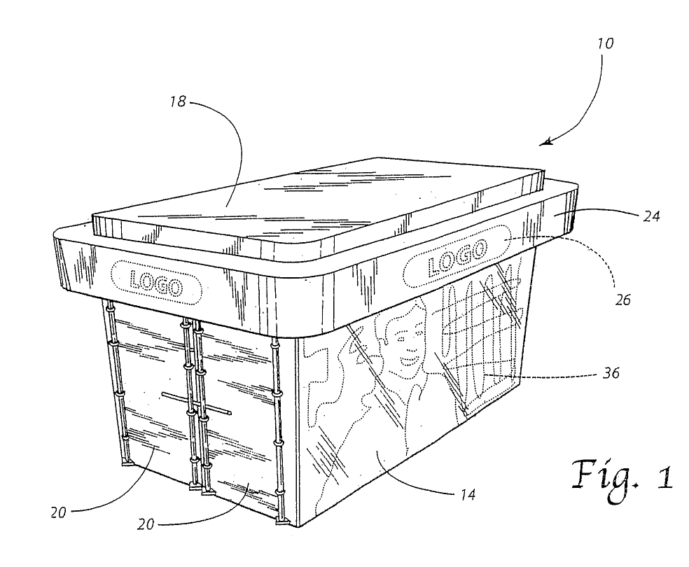

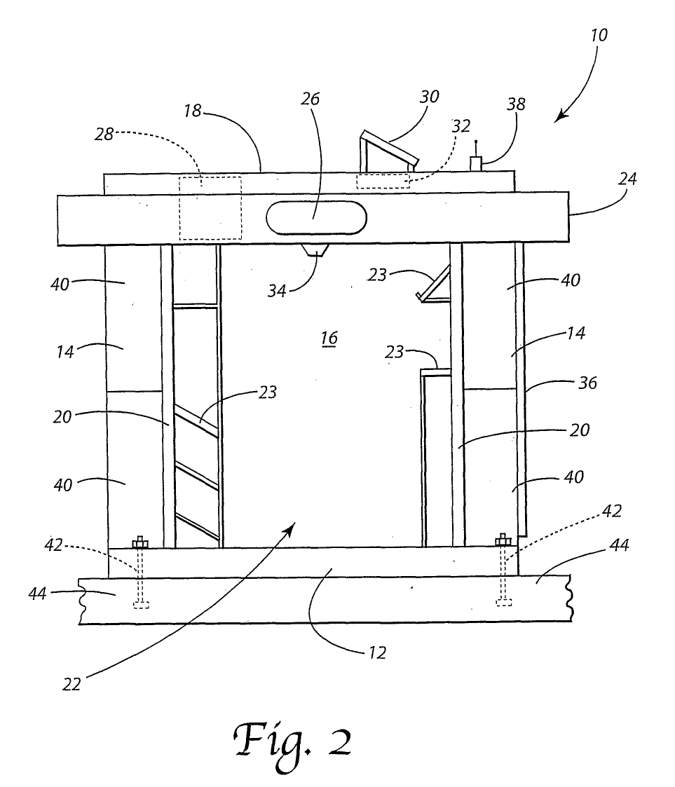

One possible construction of a storage structure a/k/a integrated advertising and storage structure or outbuilding 10 is illustrated in FIGS. 1-2. More specifically, the storage structure 10 includes a floor 12, two side walls 14, an end wall 16 and a roof 18. A pair of cooperating, locking doors 20 define a second end wall opposite the first end wall 16. Any type of door 20 useful for the intended purpose may be utilized. Together, the floor 12, side walls 14, end walls 16, roof 18 and doors 20 define an interior storage space 22. That storage space 22 may be customized to meet the needs of a product vendor and, if desired a product retailer, including particular rack, shelving and/or partitioning layouts (note shelves 23) as required or desired by the user for purposes of inventory storage and control.

Similarly, the exterior of the storage structure 10 may be customized to match the trade dress and/or architectural features of the product retailer's main building near which the storage structure 10 may be placed into service. Thus, for example, the storage structure 10 may include a decorative roof cap 24 sized and shaped to product retailer's specifications. The roof cap 24 may include product retailer advertising, trade dress or logo 26 if desired and/or as allowed by local regulations.

The storage structure 10 may also be equipped with various electrical and/or mechanical systems. For example, a refrigeration or other temperature control unit 28 may be provided on the storage structure 10 in order to provide climate control of a portion or all of the storage space 22 within the storage structure. Accordingly, products such as perishable food, dairy products, soft drinks and beer may be maintained at the desired temperatures even in hot and humid environments.

In addition, the storage structure 10 may be equipped with a solar panel 30 and cooperating battery 32 to store energy for powering an internal lighting system 34 for illuminating the storage space 22 or illuminating advertising 36 on the side wall 14, end wall 16 or other exterior component of the storage structure 10. That advertising 36 may comprise a stretched banner material and it may be front lit or back lit as desired. Alternatively, the various electrical and mechanical components of the storage structure 10 may derive their power from tapping into the lines of the local electrical utility company and/or from connection with some other form of electric generator or fuel cell.

Still further, the storage structure 10 may incorporate a radio transmitter 38 for the transmission of short range advertisements respecting products displayed in the advertising 36 appearing on the exterior surface of the storage structure 10. A particularly effective advertising combination is the use of an illuminated digital graphic advertising banner 36 in conjunction with local transmission radio advertising providing details of the particular product. This is particularly effective when advertising a product that is sold at the retailer's place of business.

The storage structure 10 may be constructed from any appropriate material. The storage structure 10 could be constructed in the manner of a standard trailer or box truck and may or may not include additional architectural details. The storage structure 10 may be constructed, for example, from modular building materials such as prefabricated panels 40 of the type shown and described in, for example, U.S. Pat. Nos. 6,279,287 to Meadows, 5,373,678 to Hesser and 6,119,427 to Wyman et al. Such modular panels typically incorporate a core of thermal insulating material sandwiched between metal or plastic sheathing. Such a construction provides both efficient and effective control of the temperature and humidity of the environment in the internal storage space 22 and excellent inclement weather durability for a long, low-maintenance service life. Structures 10 constructed from such modular building panels 40 are also characterized by high strength and will resist high winds and maintain a weather-tight enclosure to protect products held in the storage space 22 from inclement weather. This is particularly true when the structure is anchored to the ground. As illustrated in FIG. 2 this may be done by using cooperating nuts and bolts 42 as anchors. The anchor bolts 42 are held in an underlying poured concrete slab 44. The modular panels 40 also allow the storage structure 10 to be quickly and easily erected and subsequently removed in a minimal amount of time while producing a minimum of mess.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the advertising 36 may comprise the direct application of graphics to the panels 40 of the structure 10 and down lighting from a light source 42 in the roof cap 24 to illuminate those graphics. Alternatively, the advertising may comprise a banner made from an electroluminescent material of a type such as described in U.S. Pat. No. 6,637,906. Such a material is self-illuminating and when printed with graphics such as digital graphics provides a very effective advertising medium.

The structure 10 could also include an electronic display system such as a plasma monitor, liquid crystal display or like device. Further, the structure could include a rotary sign assembly of a type such as described in U.S. Pat. No. 4,021,946. Still further, it should be appreciated that the storage space 22 could be partitioned into separate compartments. An access door could be provided for each compartment. The individual storage compartments could then be leased to multiple vendors for the staging of vendor products.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A method for staging product, comprising:
placing a storage structure at a site of a product retailer;
providing storage use lights to a product vendor; and
marketing advertising space on said storage structure.

2. The method of claim 1, further including charging a fee to said product vendor for use of storage space in said storage structure.

3. The method of claim 1, further including charging said product vendor a certain percentage of said product vendor's amortized cost savings for use of storage space in said storage structure.

4. The method of claim 1, further including customizing an internal storage space in said storage structure to meet needs of said product vendor.

5. The method of claim 1, further including customizing an exterior of said storage structure to incorporate trade dress or building architecture of said product retailer.

6. The method of claim 1, further including providing climate control for an internal space in said storage structure.

7. The method of claim 1, further including rotating advertising provided on said storage structure.

8. The method of claim 1, further including illuminating advertising provided on said storage structure.

9. The method of claim 1, including providing short range radio advertising in a limited area around said storage structure.

10. The method of claim 1, further including constructing said storage structure from modular building materials.

11. The method of claim 10, including removing said storage structure after a predetermined period of time.

12. The method of claim 11, including reusing said storage structure at a different location.

13. The method of claim 1, including providing said storage structure with a projecting roof cap and down lighting advertising provided on a wall of said storage structure with a light source carried by said roof cap.

14. The method of claim 1, including providing said storage structure with interior lighting.

15. The method of claim 1, including providing back lighting for advertising on said storage structure.

16. The method of claim 1, including displaying a banner on said storage structure.

17. The method of claim 16, including using an electroluminescent material for said banner.

18. The method of claim 1, including customizing at least a portion of an internal space in said storage structure to meet needs of said product retailer.

19. A method for staging product, comprising:
placing a storage structure at a site of a product retailer; and
providing storage use rights to a product vendor for said product retailer.

20. A method for generating two revenue streams, comprising:
placing a storage structure at a site of a product retailer;
generating a first income stream in return for use of storage space provided in said storage structure; and
generating a second income stream in return for displaying advertising on said storage structure.
